(19) United States
(12) Patent Application Publication
(10) Pub. No.: US 2025/0060750 A1
(43) Pub. Date: Feb. 20, 2025

(54) Estimating Torso-Dynamics of a Seated User for Control of a Device or Avatar in Physical or Virtual Environments

(71) Applicant: The Board of Trustees of the University of Illinois, Urbana, IL (US)

(72) Inventors: Seung Yun Song, Urbana, IL (US); Joao Luiz Almeida de Souza Ramos, Arlington, MA (US); Elizabeth T. Hsiao-Wecksler, Urbana, IL (US); Chenzhang Xiao, Santa Clara, CA (US); Adam Wade Bleakney, Savoy, IL (US); Jeannette R. Elliott, Dewey, IL (US); Nadja Marin, Urbana, IL (US); Yu Chen, Urbana, IL (US); William Norris, Champaign, IL (US); Deana McDonagh, Champaign, IL (US)

(21) Appl. No.: 18/909,690

(22) Filed: Oct. 8, 2024

Related U.S. Application Data
(60) Provisional application No. 63/531,710, filed on Aug. 9, 2023.

(51) Int. Cl. G05D 1/223

(52) U.S. Cl. CPC G05D 1/223

(57) ABSTRACT

This application relates generally to robotic control/navigation and is specifically directed to a Torso-dynamics Estimation System (TES) for estimating leaning and twisting torso motions of a seated user and using such estimation or measurement signals to control movement of physical or virtual robotic devices or avatars solely using the user's upper body motion. For example, these signals can be used in lean-to-steer scenarios where the seated user is a rider/driver in a personal mobility device (e.g., powered chair or scooter), vehicle (e.g., car or drone), industrial equipment (e.g., excavator), or humanoid robot/avatar that could be in the physical or virtual worlds. Thus, TES offers a hands-free human-robot interaction for controlling a mobile device.

### CROSS REFERENCE

This application is based on and claims the benefit of priority to U.S. Provisional Patent Application No. 63/531,710, filed on Aug. 9, 2023, which is herein incorporated by reference in its entirety.

### GOVERNMENT SUPPORT

This invention was made with government support under 2024905 awarded by the National Science Foundation. The government has certain rights in the invention.

### TECHNICAL FIELD

This application relates generally to robotic control/navigation and is specifically directed to a Torso-dynamics Estimation System (TES) for estimating leaning and twisting torso motions of a seated user and using such estimation or measurement signals to control movement of physical or virtual robotic devices or avatars

### BACKGROUND

Hand-Free (HF) control of robotic devices may be applied in many application scenarios. In particularly, HF control may be used in robotic navigation by a seated user. Interfaces used for HF robotic control may involve torso motions and/or postures, which may be sensed, processed and translated in to robotic control signals.

### SUMMARY

This application relates generally to robotic control/navigation and is specifically directed to a Torso-dynamics Estimation System (TES) for estimating leaning and twisting torso motions of a seated user and using such estimation or measurement signals to control movement of physical or virtual robotic devices or avatars solely using the user's upper body motion. For example, these signals can be used in lean-to-steer scenarios where the seated user is a rider/driver in a personal mobility device (e.g., powered chair or scooter), vehicle (e.g., car or drone), industrial equipment (e.g., excavator), or humanoid robot/avatar that could be in the physical or virtual worlds. Thus, TES offers a hands-free human-robot interaction for controlling a mobile device.

The basis of the TES is the ability to measure the user's leaning motions (in the anterior-posterior and medial-lateral directions) and the torso twisting motion or 3D angular motion (about the sagittal, frontal, and transverse plane) in terms of 3D angular position, velocity, and/or acceleration. Torso 3D linear motion (in the sagittal, frontal, and transverse plane) in terms of 3D linear position, velocity, and acceleration. These torso motion signals can then be used as control signals for movement of the physical or virtual devices or avatars.

In some embodiments, these estimated torso motions may be captured using an instrumented seat (Force Sensing Seat, FSS), and/or a wearable sensor (e.g., inertial measurement unit, IMU), and/or other vision, pressure, and/or force sensing devices, and/or angle sensing devices (rotary encoders, rotary potentiometers), and/or linear position sensing devices (e.g., linear potentiometer, linear encoder) to quantify the translational (e.g., leaning in all directions) and rotational (e.g., twisting) motions of the torso, respectively. However, other embodiments are possible. Several different versions of the FSS design have been implemented. One of the versions is based on orthogonal orientations of loadcells and another version is based on a Stewart-platform orientation, as described in further detail below. The third design uses four uniaxial pancake load cells or load pads, also described in further detail below. For measuring torso twist, a wearable IMU or an instrumented backrest may be used. However, other technologies may be employed to measure twist such as vision, pressure, force, or angular/position displacement sensing systems. In a particularly example applied to a ballbot wheelchair system (as described in further detail below), a Stewart-platform based FSS and wearable IMU is used for a lean-to-steer hands-free navigation.

In some other embodiments, an instrumented backrest may be used to capture the torso's angular and linear motion in 3D. This backrest has a unique mechanism that allows the seated user to comfortably move freely while providing sufficient lumbar support and safety. This mechanism may contain multiple degrees of freedom, up to 3 translational and 3 rotational, as well as a spring-loaded mechanism. Within the backrest mechanism, there may be multiple sensors (e.g., linear and/or rotary encoders) that can be configured to measure and fully characterize the user's torso motion (i.e., linear and rotational position).

The signals from the TES, regardless of the embodiment, can be digitally processed to obtain other useful signals (e.g., velocity, acceleration) describing the torso motion in more detail. unique algorithms maybe used to obtain accurate and reliable signals that describe a wide range of users, regardless of their physique. The geometry and ergonomics of the TES can be adjusted for each user to maximize comfort and safety, as described in further detail below.

The TES can be applied in robotics, gaming, vehicle navigation, or possibly heavy equipment operation. The TES can be used as a human-robot interface to control physical mobility devices (e.g., self-balancing devices) using the user's torso movements. The benefit of controlling a mobility device with the user's torso includes freeing of hands to enable multi-tasking capabilities for the user (e.g., hold a cup of coffee or other items). The TES can be mounted on the mobility device to directly control the device. In addition, the TES can be mounted outside of the device to remotely control the device. In this use case, the TES can be used to teleoperate in physical and/or virtual environments, systems such as an avatar, robot, vehicle, or device. In addition to these examples, the TES might be useful for some control aspects of heavy machinery, such as backhoes, or manufacturing or healthcare areas, such as robotic limbs. The TES provides a hands-free control of the virtual robot/figure, enabling the user to utilize their hands for other tasks while using the torso for control of specific tasks. In addition, the TES can offer valuable information (e.g., user's weight, upper body posture, center of pressure) that could be used in the system's safety and performance.

In some example implementations, a system is disclosed. The system may include a Torso-dynamics Estimation System (TES) configured to determine real-time kinetics information and/or real-time kinematics information of a torso of a seated subject; and a controller configured to: process the real-time kinetics information and/or the real-time kinematics information to generate a set of detected torso motions or a set of detected torso positions; and generate control signals for navigating a robotic device based on the set of detected torso motions or the set of detected torso positions.

In the example implementations above, the TES comprises: an instrumented seat; and a wearable sensor.

In any one of the example implementations above, the instrumented seat is configured to determine the real-time kinetics information of the torso and the wearable sensor is configured to determine the real-time kinematics information of the torso.

In any one of the example implementations above, the instrumented seat comprises a base and a seating platform floatingly coupled to the seating platform.

In any one of the example implementations above, the seating platform is floatingly coupled to and supported by a plurality of axial loadcells.

In any one of the example implementations above, the plurality of axial loadcells comprise 6 uniaxial loadcells configured in three normal directions.

In any one of the example implementations above, a number axial loadcells arranged in a direction most aligned with gravity is larger than numbers of axial load cells in other directions.

In any one of the example implementations above, the plurality of axial loadcells are configured symmetrically around a vertical axis.

In any one of the example implementations above, the plurality of axial loadcells comprise 6 uniaxial load cells.

In any one of the example implementations above, each of the plurality of axial loadcells comprises two force members and are coupled to the seating platform and the base via ball joints.

In any one of the example implementations above, the ball joints for the plurality of axial loadcells on the base are not located in a single plane.

In any one of the example implementations above, the wearable sensor comprises an Inertial Measurement Unit (IMU) worn by the seated subject.

In any one of the example implementations above, the IMU comprises at least one 3-axis gyroscope, one 3-axis accelerometer, and one 3-axis magnetometer.

In any one of the example implementations above, the TES further comprises at least one of an instrumented backrest and an optical sensor.

In any one of the example implementations above, the TES comprises the instrumented backrest and the instrumented backrest comprises a plurality of angular/linear position sensors for detecting the real-time kinetics information of the torso.

In any one of the example implementations above, the TES comprises the instrumented backrest which comprises a movable backrest, a fixed lumbar support, a base, and prismatic and/or revolute joints, the movable backrest being configured to be moveable and always in contact with the seated subject.

In any one of the example implementations above, a number of the prismatic and/or revolute joints ranges from 1˜6, a combination of the prismatic and/or revolute joints being adaptably configured.

In any one of the example implementations above, the joints are configured in a parallel or serial configuration with respect to the movable backrest.

In any one of the example implementations above, each of the prismatic joints comprises a linear spring, a position sensor, and a sliding mechanism.

In any one of the example implementations above, each of the revolute joints comprises a torsional spring, an angle sensor, a bearing, and a rotating mechanism.

In any one of the example implementations above, the moveable backrest and the lumbar support are adjustable in terms of height and depth.

In any one of the example implementations above, the TES comprises the instrumented backrest and the instrumented backrest is adjustable to accommodate physiques of the seated subject.

In any one of the example implementations above, the plurality of angular/linear position sensors are arranged in a parallel or serial configuration.

In any one of the example implementations above, the TES comprises the instrumented backrest and the instrumented backrest comprises at least one pressure sensitive pad for detecting the real-time kinetics information of the torso.

In any one of the example implementations above, the system further comprises a wheelchair having a ballbot driving train, and wherein the base of the instrumented seat is integrated with a frame of the wheelchair.

In any one of the example implementations above, the system further comprises a wheelchair having a ballbot driving train, and wherein instrumented seat is detachably coupled to the wheelchair.

In any one of the example implementations above, the set of detected torso positions are mapped to the control signals for setting a robotic motion whereas the set of detected torso motions are mapped to the control signals for changes of the robotic motion.

In any one of the example implementations above, the plurality of axial loadcells comprise 4 uniaxial loadcells configured such that the loading axes are aligned in the same direction, which is orthogonal to the base and seating platform.

In any one of the example implementations above, a 6-axis force/torque sensor is placed between the base and seating platform.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example Torso-dynamics Estimation System (TES) for estimating leaning and twisting torso motions of a seated user and using such estimation or measurement signals to control movement of physical or virtual robotic devices or avatars.

FIG. 2 illustrates example sensing subsystems of a TES.

FIG. 3 shows an example instrumented seat of a TES.

FIG. 4 shows another example instrumented seat of a TES.

FIG. 5A shows a practical example instrumented seat subsystem of a TES.

FIG. 5B shows another practical example instrumented seat subsystem of a TES.

FIG. 6 shows an example 6-loadcell configuration for an instrumented seat subsystem of a TES.

FIG. 7A and FIG. 7B show further details of the example 6-loadcell configuration of the instrument seat subsystem of the TES of FIG. 6 in two different views.

FIG. 8 shows another example 6-loadcell configuration for an instrumented seat subsystem of a TES.

FIGS. 9A and 9B show further details of the example 6-loadcell configuration of the instrument seat subsystem of the TES of FIG. 8.

FIG. 10 shows an example 4-loadcell configuration for an instrumented seat subsystem of a TES.

FIG. 11 shows an example single loadcell configuration for an instrumented seat subsystem of a TES.

FIG. 12 illustrates operation principle of an example instrumented backrest for a TES.

FIG. 13A illustrates an example instrumented backrest installed with loadcells for a TES.

FIG. 13B illustrates an example instrumented backrest installed with angular/linear position sensors for a TES.

FIG. 13C, FIGS. 13D, and 13E illustrate an example movable instrumented backrest installed relation to a lumbar support, a prismatic joint, and a plurality of revolute joints.

FIG. 13F and FIG. 13G illustrates height and depth adjustment of the instrumented backrest and the lumber support of FIGS. 13D-13E.

FIG. 14 illustrates an example instrumented backrest installed with pressure sensing pads for a TES.

FIG. 15 illustrates principles of using an Inertial Measurement Units (IMU) as part of a TES.

FIG. 16 illustrates principles of using an optical sensor as part of a TES.

FIG. 17 illustrates principles for training and testing use of a TES.

### DETAILED DESCRIPTION

The following description and drawing set forth certain illustrative implementations of the disclosure in detail, which are indicative of several example manners in which the various principles of the disclosure may be carried out. The illustrated examples, however, are not exhaustive of the many possible embodiments of the disclosure. Other objects, advantages, and novel features of the disclosure will be set forth in the following detailed description when considered in conjunction with the drawings.

By way of introduction, estimations of torso kinetics and/or kinematics of a seated person are essential in physical human-robot interaction (pHRIs) that incorporates hands-free (HF) control for navigating riding mobile robots, remote mobile robots, or an avatar, in either physical or virtual environments. HF control is desired in many situations, particular for a person with hand-related handicaps. For example, a mobile robot may include but is not limited to electrically powered wheel chair, two-wheeled self-balancing devices, self-balancing ballbot, or the like. In this disclosure, the person sitting on a seat (the seated person) may be referred to as a controlling entity or a subject, whereas the robots or the avatar, either local, remote, or virtual, may be referred to as controlled entities, or robots. The term “kinetics” may be used to refer to forces and torques that the controlling entity may exert on the seat as a result of torso motions, whereas the term “kinematics” may be used to refer to the motions of the torso of the controlling entity without regards to forces and torques. Further in this disclosure, the term “dynamics” or “motions” or “mechanics” may be used broadly to refer to either kinetics or kinematics or both. Further, the term “robot” is used to generally refer to a controlled entity, including a physical robot or avatar, being either local, or remote. For example, these signals can be used in lean-to-steer scenarios where the seated user is a rider/driver in a personal mobility device (e.g., powered chair or scooter), vehicle (e.g., car or drone), industrial equipment (e.g., excavator), or humanoid robot/avatar that could be in the physical or virtual worlds. Thus, TES offers a hands-free human-robot interaction for controlling a mobile device.

The goal of such control system is to consistently generate estimations of the torso dynamics or motions that can be easily learned by the controlling entity as reasonably accurate representation of control intentions of the controlling entity. As described in further detail below, a system that enables such robotic control via torso dynamics or motions would include a sensing or detecting subsystem that is capable of measuring/estimating the torso dynamics or motions (torso kinetics and/or kinematics) in real time and would also include circuitry that is capable of generating motion parameters from the kinetic and kinematic measurements (parameterization of the torso motions) and converting the motion parameters into control signals towards the robots. Such s sensing or detecting subsystem for torso motions may be referred to as a Torso dynamics Estimation System (TES).

For a practical application that utilizes robotic control via torso motions, particularly the one involving riding robotic wheelchairs, it may be required that the corresponding TES be designed according to a combination of economics, accuracy, form factor, portability, and other restrictions, and to provide a sufficient number of torso dynamics or motion parameters (e.g., both a sufficient set of kinetic parameters and a sufficient set of kinematic parameters) to generate full and accurate robotic control signals. In such applications, a TES that relies on a particular research-grade instrumentation, e.g., force resistive sensors, research-grade pressure mats, research-grade force plate, research-grade Inertial Measurement Units (IMUs), trunk muscle electromyography (EMG), research grad optical analytic systems may not simultaneously satisfy all such restrictions and requirements. For example, these sensors or sensor subsystems may be costly, bulky, heavy, difficult to customize, and/or incapable of comprehensively estimating torso dynamics/motions/mechanics (e.g., measuring both kinetics and kinematics).

In this disclosure, various versions of a compact, lightweight, accurate, and versatile TES are described. Such TES implementations are capable of estimating kinetic and/or kinematic signals related to torso motions of seated users in real time. The disclosed TES may include at least one of: an instrumented seat such as a custom Force Sensing Seat (FSS), an instrumented backrest for the seat, a wearable sensor such as an IMU, and an optical sensor. The FSS and/or the instrumented backrest, for example, may be configured to estimate torso kinetics. The wearable sensor and/or optical sensor may be configured to estimate the kinematics. Human subject tests may be conducted to validate the accuracy of the example TES by comparing measurements from the FSS, the backrest, IMU, and/or the optical sensor, to standard equipment using a research-grade force plate and precision motion capture system.

The disclosed TES implementations may be applied to various types of navigating riding mobile robots, remote mobile robots, or an avatar, in either physical or virtual environments. For example, a mobile robot may include but is not limited to electrically powered wheelchairs, two-wheeled self-balancing devices, self-balancing ballbot, or the like. The output of the TES implementations may be mapped, adapted, or otherwise transformed in to control signals that operate to navigation of the controlled robots by impacting triggering, or modifying the speed, acceleration, turning, rotation and/or other motions of the robots. For a particular example, the disclosed TES implementations may be integrated with a physical self-balancing ballbot omnidirectional personal mobility device that function as a wheelchair for a seated person to navigation based on torso motions/dynamics. Such a personal mobility device may be referred to as a Personalized Unique Rolling Experience (PURE) system, as described in Applicant's U.S. patent application Ser. No. 17/464,446, which is hereby incorporated by reference in its entirety. The TES for a PURE system, for example, may be designed in a compact manner such that its FSS has a size not extending beyond a footprint of the PURE system which may be approximated as wide as the rider's hips.

The FSS portion of the TES described in this disclosure may be configured as an attachable device with mechanical and electric interfaces that may enable a flexible usage and switching of the TES between different robotic devices and usage environments.

In some example implementations, the types of torso motions or groups of types of torso motions that a user is preferred to use as control input may be configurable, e.g., may be provided to user as options. Each of such options may correspond to a specifically determined mapping between a subset of the torso motions/states and navigational commands or states.

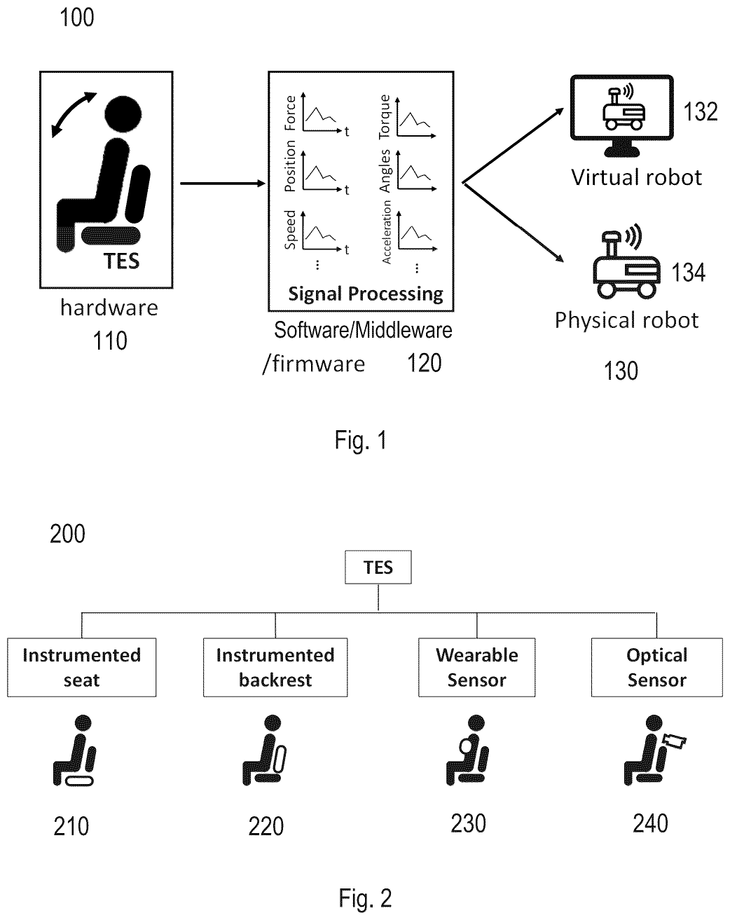

FIG. 1 illustrates an example system 100 for robotic control based on torso motions. The system 100 includes a TES 110, a software/middleware/firmware 120 running on general purpose or special purpose circuitry, and the one or more robots 130, including virtual robots 132 and/or physical robots 134. As described above, the TES 110 may be configured for sensing and detecting torso dynamics/motions/mechanics of a seated controlling entity. The software/middleware/firmware 120 may be configured to process the output from the TES and generate control signals to the robots 130 for robotic navigation.

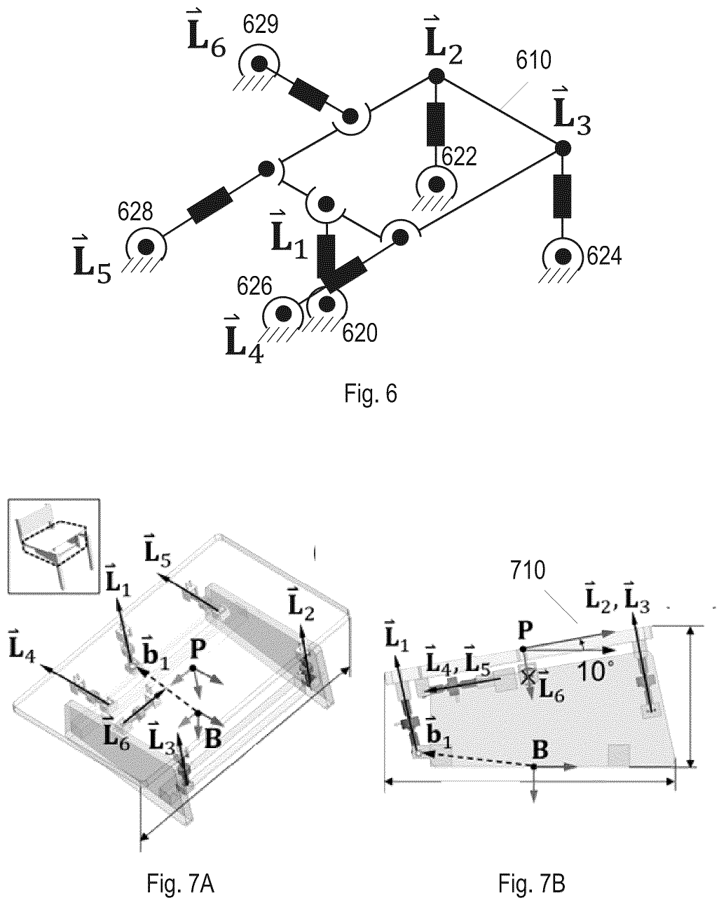

FIG. 2 illustrates general components of the TES 200, some of which may be optional. An actual TES may be any combination of these components. For example, the TES 200 may include an instrumented seat 210, an instrumented backrest 220, a wearable sensor 230, and an optical sensor 240. The instrumented seat 210 and the instrumented backrest 220 may be instrumented to include sensors that are configured to measure the kinetics associated with the torso of the seated controlling entity as perceived by the seat of the backrest. The instrumented seat 210, for example, may include force and/or torque sensors that are geometrically configured in various optional layouts, including an orthogonal layout, a Steward platform layout, a pancake design layout, a single loadcell layout, or the like, as described in further detail below in relation to FIGS. 6-11. The instrumented backrest 220, for example may include force and/or torque sensors that are geometrically configured in the orthogonal layout or steward platform layout, or the like, or to include air pads with pressure sensing functions. The wearable sensor 230 and the optical sensor 240 may be configured to measure the kinematics of the torso of the seated controlling entity, such as spatial and angular positions and motions of the torso or parts of the torso. The wearable sensor 230 for example may include an IMU, as described in further detail below. The optical sensor 240 may be implemented in various manners, including LiDar (Light Detection and ranging), or sonar, or optical camera based stereo images with or without depth measurements or infred imaging with imaging analytics to determine torso positions and/or postures, or the like.

The instrumented seat 210 of FIG. 2 may be designed in various manners. In some example implementations, the instrumented seat 210 may include a seating platform with a seating surface and a base. The seating platform, for example may be floatingly coupled to the base via one or more sensing elements arranged in various geometries. The base, for example may be a part of the instrumented seat, which may be attached or coupled to, for example, a platform of a riding robot being controlled/navigated. Alternatively, the base may be part of the riding robot being controlled/navigated. In other words, the sensing elements may directly couple the robot to the seating platform.

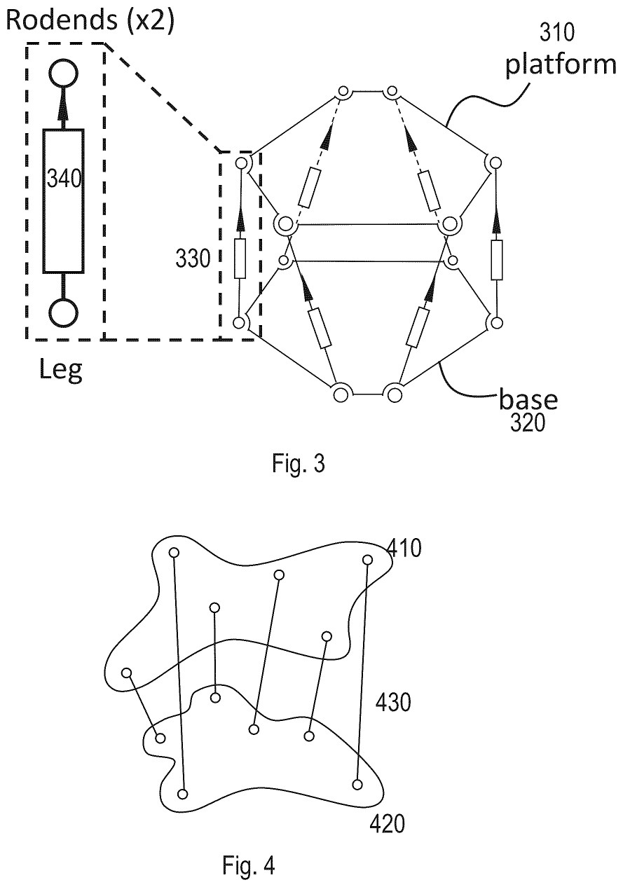

FIG. 3 provides an example implementation of the instrumented seat 210 of FIG. 2 above. The implementation of the example instrumented seat of FIG. 3 includes a seating platform 310 as a floating rigid body and a base 320 coupled via a preconfigured number of legs 330 acting as supports for both floating the seating platform 310 and as the sensors for kinetics measurements. Each of the legs 330 may be configured, for example, in a rod-like configuration. The number of legs 330, N, for example may be N=6, or other numbers. Each of the legs 330 may be configured to sense an axial force in real-time along the rod direction as shown by the arrows in FIG. 3, when the controlling entity is seated over the seating platform 310. Torques exerted on the seating platform by the seated controlling entity may be determined by the axial forces and arms of the forces to a fixed reference point of the system. The N legs 330 thus represent maximum N degrees of freedom for force and torque measurement (kinetics) in real-time.

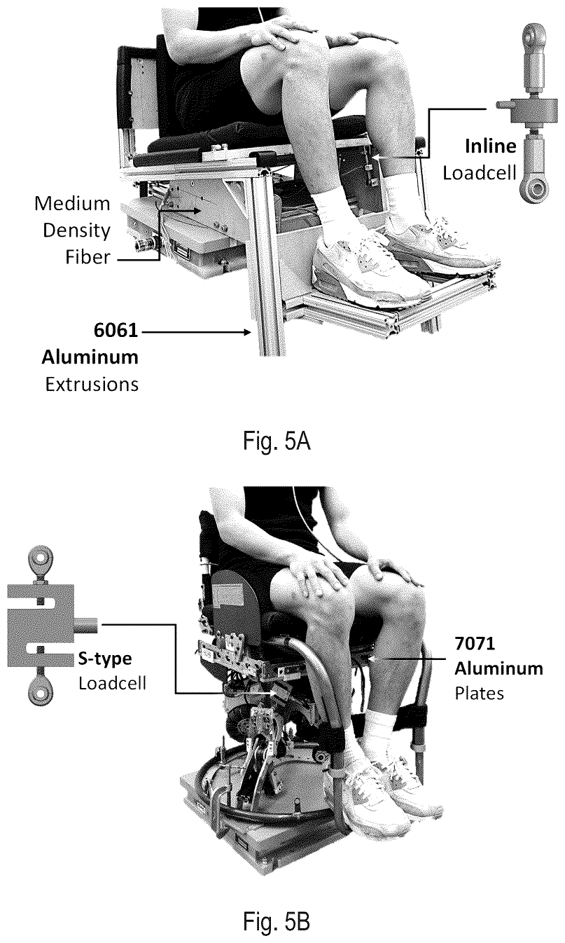

Each of the example legs 330 may be implemented as a uniaxial loadcell with two spherical joints at both ends such that each leg is a two-force member in which the axial loads are measured, as shown by 340 in FIG. 3. Such loadcells may be implemented in various configurations. For example, the loadcells may be of inline type or S-type, as shown in FIG. 5A and FIG. 5B, respectively, and as described in further detail below.

The configuration of the axial directions of the legs 330 for floating the seating platform 310 on the base 320 may be designed to adapt to a particular application scenario and/or to physical characteristics of the controlling entity seating on the seating platform 310 in order to provide more responsive and accurate control of the robots by the torso motions of the controlling entity. The configuration of FIG. 3 is provided merely as an example. As shown in FIG. 4, the example N uniaxial legs 430 between the seating platform 410 and the base 420 may be configured in any manners (any axial directions). In addition, the form factor of the seating platform may be adapted in any manner and may be designed according to the physical characteristics of the seating controlling entity, and the form factor of the base may be adapted to, for example, the riding robot that the instrumented seating platform is mounted on. In the situation that the seating platform 410 is coupled to the riding robots directly via the legs, the configuration of the legs may be adapted to the form factor and geometric characteristics of the frame of the riding robot. In addition, the coupling point of the legs to the seating platform or the base need not be in a single plane and the locations of the coupling points may be flexibly configured according to the application and the physical characteristics of the seating platform, the base, and/or the controlling entity being seated on the seating platform.

Example practical implementations of the instrumented seat above are further shown in FIG. 5A and FIG. 5B. FIG. 5A shows an example seating platform and a base constructed using medium density fiber (MDF) boards and aluminum extrusions and inline loadcells for floating the seating platform over the base. FIG. 5A shows an example seating platform and a base constructed using aluminum plates (e.g., water-jetting sheets of 7075-T6 aluminum) and S-type of loadcells for floating the seating platform over the base (which may use extrusions of 6105-T5 aluminum).

A specific example of a 6-degree of freedom loadcell configuration is illustrated in FIG. 6 with 6 uniaxial inline type load cells anchored to the seating platform 610 and the various anchor points 620, 622, 624, 626, 628, and 629 on the base. In the configuration of FIG. 6, the uniaxial loadcell are arranged in three normal/perpendicular directions in vertical (gravity) direction and in the horizontal plane. Such a configuration may be referred as an orthogonal loadcell configuration. The uniaxial force vectors are represented by L₁ through L₆. Considering the gravity pull of the controlling entity seating on the seating platform, 3 loadcells L₁, L₂, and L₃ are arranged in the vertical direction. Also considering that there may be larger torso motion of the seated controlling entity along the front-back direction than the left-right direction, 2 loadcells L₄ and L₅ are arranged along the front-back direction in the horizontal plane wherein 1 loadcell L₆ is arranged in the left-right direction in the horizontal plane. An actual implementation of this orthogonal loadcell configuration with a seating platform and a base is shown in FIG. 7A and FIG. 7B, from an isometric view and a side view, respectively, with the uniaxial force vectors L₁ through L₆ shown. As shown in FIGS. 7A and 7B, the setting platform 710 may be tilted downward in the back direction from the horizontal plane and the normal axis for the loadcells may be correspondingly tilted from the normal gravity direction and the horizontal plane.

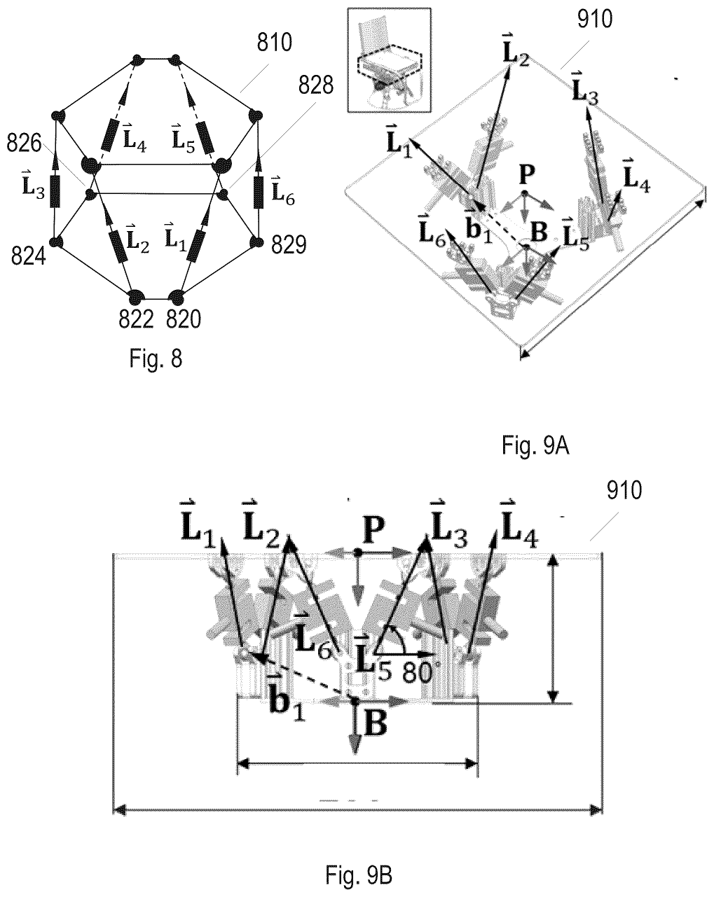

Another specific example of a 6-degree of freedom loadcell configuration is illustrated in FIG. 8 with 6 uniaxial S-shaped load cells anchored to the seating platform 810 and the various anchor points 820, 822, 824, 826, 828, and 829 on the base. In the example configuration of FIG. 8, the uniaxial loadcell are arranged in a Steward platform configuration. The uniaxial force vectors are represented by L₁ through L₆. The loadcells, for example, may be symmetrically arranged around the vertical axis along the gravity direction. The axial forces of the loadcells all measure part of the vertical component of the force and each loadcell also measure a force component in the horizontal plane. An actual implementation of this Steward platform loadcell configuration with a seating platform 910 and a base is shown in FIG. 9A and FIG. 9B, from an isometric view and a side view, respectively, with the uniaxial force vectors L₁ through L₆ shown.

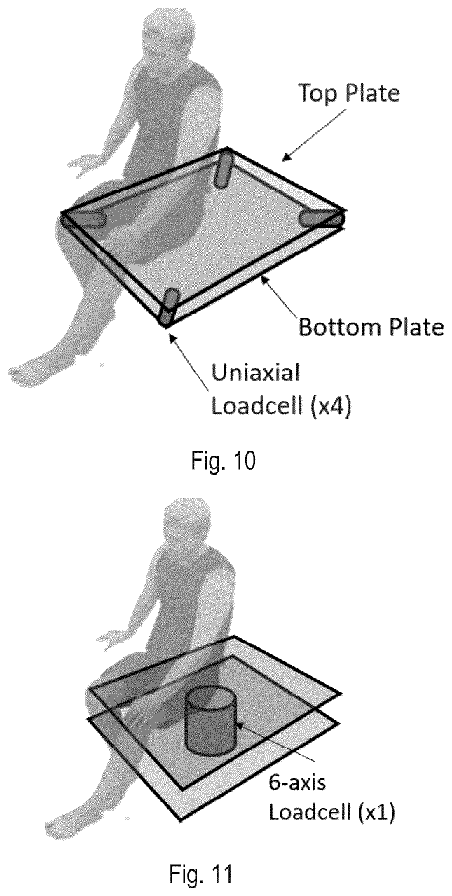

An alternative example of 4-degree of freedom loadcell configuration is further illustrated in FIG. 10. For example, the four uniaxial loadcells may be symmetrically arranged around the vertical axis for floatingly support the seating platform (labeled as top plate in FIG. 10). Such loadcells may be referred to as pancake loadcells. Another example of loadcell configuration is further illustrated in FIG. 11. In the example configuration of FIG. 11, a single load cell may be used. However, the load cell of FIG. 11 may supply multiple axis readings (e.g., 6-axis forces and torques).

The instrumented seat of FIGS. 3-9 may be referred to as a Force Sensing Seat (FSS). Various designing goals for such an FSS may include compactness, portability, versatility in design and manufacturing, robustness to fabrication error, cost-effectiveness, measurement accuracy, and the like. The FSS may be designed to output resultant applied forces and torques and location of the center of pressure (COP) on the seat. More specifically, the 3D forces (F=[Fₓ F_{y} Fₓ]^{T}) and torques (T=[Tₓ T_{y} Tₓ]^{T}) (i.e., wrench (W=[F, T]^{T})) and 2D center of pressure (COP=[COPₓ COP_{y}]^{T}) may be measured or derived in real-time.

In general, the FSS described above includes a floating rigid body (shown as the seating platform) which may be constrained in N degrees-of-freedom (e.g., 6 degrees of freedom) by the six legs with respect to the fixed base. For legs configure as uniaxial loadcell with two spherical joints at both ends and a two-force member, the wrench W applied on the FSS plate may be transmitted through the six legs axially and may be in static equilibrium with the six axial forces (Lᵢ, i={1, 2, . . . 6}):

$$\overline{W} = H [ \begin{matrix}{f}_{A} \\ ⋮ \\ {f}_{6}\end{matrix} ] = [ \begin{matrix}{\hat{u}}_{1} & … & {\hat{u}}_{6} \\ {\overline{b}}_{1} \times {\hat{u}}_{1} & … & {\overline{b}}_{6} \times {\hat{u}}_{6}\end{matrix} ] [ \begin{matrix}{f}_{1} \\ ⋮ \\ {f}_{6}\end{matrix} ]$$

where bi represents the position vector from an origin of base frame B to the connection point of the ith leg at the base (as shown in FIGS. 7A, 7B, 9A, and 9B. Each Lᵢ may be computed from the corresponding loadcell readings (ƒi) and the unit vector (uᵢ) along leg i as defined in the global coordinate frame of the FSS. W applied on the plate frame P can be calculated by multiplying a force transformation matrix H to the load cell readings (ƒi). Note that calibration of the H may be needed to compensate for manufacturing and assembly errors of the FSS. Then, the COP may be computed from W.

The design goal of the FSS include estimating kinetic signals, while satisfying the desired load capacities and with high accuracies. In some experiments, efforts may be made to use commercially available and cost-effective key components for the FSS to provide a practical solution for developers. The design of FSS critically depends on the load capacity requirement of the seat. In applications, such as riding robot navigation, the load capacity may be determined based on physical characteristics of the controlling entity seating on the FSS and potential motion-induced load. Preliminary force data of a single controlling entity (e.g., of 80 kg) that execute various torso movements, for example, may be collected as a guide for determining the load capacity requirement and the selection of the loadcells. An example set of load capacity requirements for the configuration of FIGS. 6-9 are shown in Table 1, in which a safety factor of 2 is included on top of normal base requirement of load capacities.

TABLE 1
Example Desired Load Estimation Specifications

| | Fₓ | F_{y} | F_{z} | T_{X} | T_{y} | T_{Z} | COPₓ | COP_{y} |
|---|---|---|---|---|---|---|---|---|
| | (N) | (N) | (N) | (Nm) | (Nm) | (Nm) | (mm) | (mm) |
| Capacity | 200 | 200 | 1600 | 200 | 400 | 40 | 400 | 200 |
| Accuracy | 5 | 5 | 40 | 5 | 5 | 1 | 10 | 5 |

The versatility of design of the FSS above is critical to satisfy the strict spatial requirements for some applications (such as PURE). These spatial requirements may include physical size constraints and form factor constraints. The example FSS above that utilizes six loadcells in strategically arranged configurations of FIGS. 6-9, for example, may help achieve the versatility in FSS design. The design of FIGS. 6-7 may require a sufficiently large footprint to accommodate users with various physiques. The design of FIGS. 8-9, when applied to PURE, may need to be physically compact to ensure that the overall device's dimensions are similar to if not smaller than a typical manual wheelchair and that the device is efficiently packaged with other components (e.g., drivetrain, electronics) and is easily accessible for maintenance and repairs.

In the example FSS configuration of FIGS. 6-7, as described above, three of the six legs may be mounted normal to the vertical (z-axis) plane of the seating platform or base while the other three may be placed on the horizontal (x, y) plane. This configuration allowed for intuitive inspection of the sensor readings of the loadcells since the loadcells are parallel to the coordinate axes of the seating platform or base in such a configuration. For example, a non-zero reading may be expected for the 4^{th} and 5^{th} loadcells of FIGS. 6-7, i.e., L₄, and L₅, and near-zero readings for the other four loadcells, L₁, L₂, L₃, L₆, if an external load along the x-axis is applied on the seating platform.

For the application of the FSS to PURE, as shown in the example FSS configuration of FIGS. 8-9, all six legs may be arranged in the semi-regular hexagonal structure following the Stewart Platform configuration. The semi-regular hexagonal structure and symmetrically isotropic arranged legs allow for FSS estimations to be more isotropic (e.g., the sensors are equally sensitive to all directions) for a given wrench. The dimensions of the seating platform may be larger than the base since the it may need to be configured to hold many critical components such as the seat, electronics, and batteries. The connection points for the seating platform may be further spread out from the center axis than for the base to better accommodate the form factor of PURE (e.g., in an hourglass shape-wide top due to the seat, slim middle due to compact drivetrain, and wide bottom due to the support structure).

Another example benefit of the versatile leg arrangements for the PURE application and other applications is that the load sensing behaviors of the legs may be customized to fit the load sensing requirements (such as in Table 1). By varying the orientation and position of the legs, the force transformation matrix H above may be altered, enabling adaptivity of the load capacity and sensitivity for sensing forces and torques in different axes for different needs. The appropriate leg configurations for the FSS may be first determined using the desirable load capacities for each axis. The determination of desirable load sensitivities may take priority over the sensitivity because the FSS estimations are generally sensitive enough for PURE's application for almost any given leg arrangements and loadcells, and the load capacities may take higher priority than sensitivities since safety was a more critical factor. The leg configuration may be adapted to physiques and torso motion habit of the controlling entity seating on the seating platform to provide more accurate control by more intuitive and easier to learn motions.

In some example implementations, other design changes could be made to the leg design and arrangements to adjust the loading behavior of an FSS. For legs arranged orthogonally to the base frame, such as in FIGS. 6-7, increasing the number of legs along the loaded direction or simply selecting a uniaxial loadcell with higher load capacity may increase the load capacity and sensitivity. Loadcells along the z-axis may have higher load capacities (e.g., 100 kg) as shown in Table 1 since these loadcells carry higher loads due to the controlling seating entity's weight. The loadcells along the x, y-axis may have smaller load capacities (e.g., 20 kg, 30 kg, as shown in Table 1), but higher sensitivities since the expected loads along these directions are smaller in magnitude. There may be a greater number of loadcells along the z-axis (n=3) than x- or y-axis (n=2 for x-axis, n=1 for y-axis) for similar reasons. For the example implementations of FIGS. 8-9, all loadcells may have identical load capacities (e.g., 100 kg) since all loadcells share approximately similar loads due to the symmetric loadcell arrangement.

For both FSS designs above and for FSS designs in general, commercially available low-cost uniaxial loadcells and loadcell amplifiers may be chosen for economic considerations. As an example, the FSS design of FIGS. 6-7 utilizes six loadcells e.g., (DYMH-103, Calt, China) with different load capacities depending on the axis (X-axis: 20 kg, Y-axis: 30 kg, Z-axis: 100 kg) with six identical amplifiers (NAU7802, Nuvoton, Taiwan). The FSS design of FIGS. 8-9 uses six identical load cells (CZL301C, Hualanhai, China) with three dual-amplifiers (ABE-01, Robotshop, Canada). While these loadcells and their amplifiers are mostly hobby-grade, their performance may for the PURE application may be easily verified. For example, loads from 0 to 75% of the loadcell's load capacity (at some increments of, for example, 20 N) may be added to one end of a leg while the other end of the leg is fixed. The loadcell readings and the actual load value may be compared to analyze the performance metrics (e.g., hysteresis, non-linearity, zero output, and the like) of each loadcell. The performance results demonstrate that the chosen loadcells and amplifiers are sufficiently accurate and repeatable to be used for PURE's application. The empirically measured values of the hysteresis, load capacity, non-linearity, and zero output for the loadcells in both the design of FIGS. 6-7 and FIGS. 8-9 are all within 0.05% of the reported values.

The overall FSS electrical system, as part of, for example, 120 of FIG. 1, may be integrated with the FSS. Such a system may include a microcontroller (e.g., Teensy 4.1, PJRC, USA) and the loadcell amplifiers. The loadcell data along with a time stamp (as well as other sensing data, such as IMU data) may be locally processed or transmitted another device (e.g., a networked device) for processing. For experiment purposes, the data may be transited to a PC via micro-USB cable at 100 Hz. The amplifier's gains may be tuned to ensure that the loadcell's maximum capacity could be reached without saturation. The amplifier's zero-offsets may also be adjusted to ensure the loadcell's bidirectionality (e.g., to endure the ability to measure loads in tension and compression equally). For example, for the design of FIGS. 6-7, the chosen loadcell amplifier may provide programmable gains and sampling rates, higher resolution, and a built-in filter for rejecting 50 Hz and 60 Hz noise due to electric humming. The amplifiers may be addressed and multiplexed connected to the electronics, e.g., via a i2c addresses using a multiplexer (e.g., TCA9548A, Texas Ins., USA) so as to enable timely reading of multiple loadcell amplifier simultaneously. Alternatively, the loadcell amplifiers may be configured to directly communicate with the microcontroller via analog signal in order to sample the loadcell signals at higher frequency (e.g., 400 Hz) and to simplify the electrical system by removing the multiplexer.

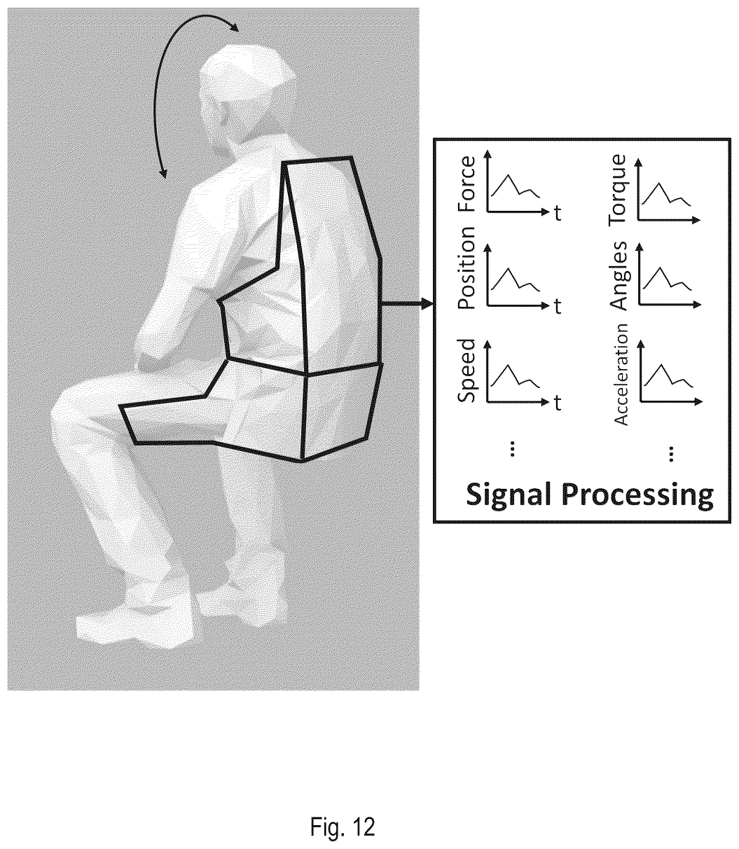

FIG. 12 illustrates utilization of a backrest as part of the TES and with sensing functions to facilitate detection of torso kinetics for the robotic control described above. FIG. 12 illustrates that the backseat, alternative or additional to the seating platform above, may be configured with sensors can generate outputs as a result of interactions between the controlling entity and the backrest with torso motions. Such outputs as shown in FIG. 12 may be processed to generate control signals, alone or in combination of the sensing signals from the FSS.

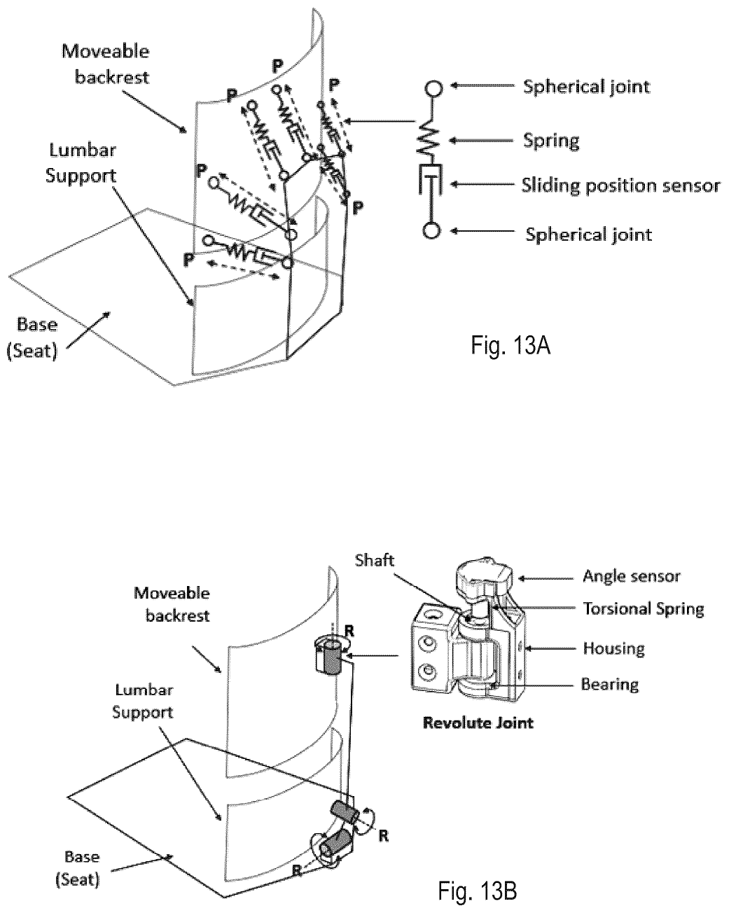

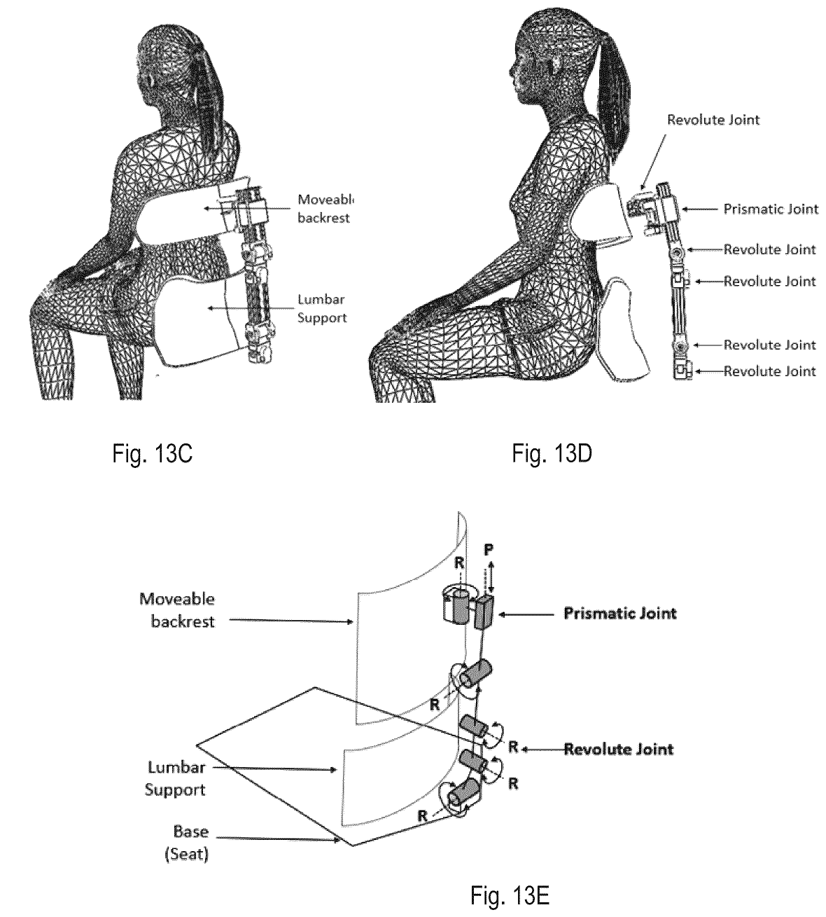

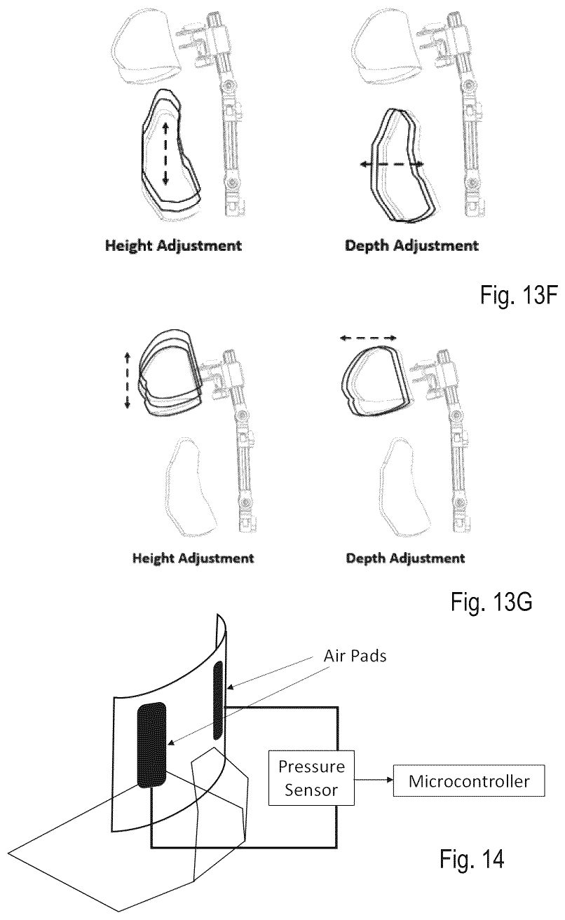

For example, the instrumented backrest may include a movable backrest, a lumbar support fixedly installed with the seating platform (base), a plurality of angular or linear position sensors installed between the movable backrest and the lumbar support (or its extension), as shown in FIG. 13A through FIG. 13E. Each of the angular or linear position sensors, for example, may include a prismatic (P) and/or revolute (R) joints. The movable backrest may be configured to be movable relative to the seating platform and the fixed lumbar support (or its extension), and the seated subject may be always in contact with and interact with the movable backrest in order to generate control signals via the angular or linear position sensors.

For example, a plurality of prismatic joints, represented by “P”, may be used, as shown in FIG. 13A. Each of the prismatic joints may be configured as a linear positional sensor and may include spherical joints at its two ends for coupling to the movable backrest and the lumbar support, and may further include a linear spring, and a sliding position sensor (or sliding mechanism), as shown in FIG. 13A.

For another example, a plurality of revolute joints, represented by “R”, may be used, as shown in FIG. 13B. Each of the revolute joints may be configured to revolve around an axis in a particular direction. Each revolute joint may include, for example, a torsional spring, an angle sensor, a bearing, and a rotating mechanism, and a housing, as shown in FIG. 13B.

In some example implementations, one or more of the prismatic joints of FIG. 13A and one or more of the revolute joints of FIG. 13B may be used and arranged in a mixed manner, as shown in FIG. 13C through FIG. 13G. In some example implementations, N angular or linear positional sensors may be employed, e.g., N may be in the range of 1-6. Any combination of numbers of prismatic joints and revolute joints may be configured. Examples for sensor configurations may include but are not limited to: PPPPPP, RRR, RPRRRR, as shown in FIGS. 13A to 13E, and any other configurations. The N angular or linear positional sensors may be arranged in any positional, orientational, or geometric relationships. For example, FIG. 13 B shows a configuration where three revolve joints are used. The three revolve joints are configured to detect rotation in three normal directions. FIG. 13E shows a configuration having a RPRRRR arrangement to detect both position and rotation.

In some example implementations, the movable backrest may be coupled to the plurality of joints in parallel (such as in the implementation of FIG. 13A) This may be referred to as parallel configuration. In some other example implementations, the plurality of joints may be connected in series and the movable backrest may be coupled to one of the plurality joints (e.g., the end joint). This may be referred to as serial configuration.

For example, the angular joints may be configured as an assembly attached to the movable backrest, as shown in FIG. 13C and FIG. D, where the joint assembly is coupled to the movable backrest via a first revolute joint in the assembly, and the joint assembly include a prismatic joint and a sequence of revolute joints along different directions, as further indicated in FIG. 13E.

In some example implementations, the movable backrest and the lumbar support may be configured to be adjustable in depth and/or height, as shown in FIG. 13F (for the lumbar support) and FIG. 13G (for the movable backrest). Such adjustment may be used to adapt the TES to a wide range of physiques of the riding entity or subject.

For another example, as shown in FIG. 14, air pads with pressure sensing functions may be installed on the backrest. Pressure signals reflecting the interactions between the torso of the controlling entity and the backrest may be detected and processed via the pressure sensing and may be provided to a processing circuitry (e.g., microprocessors) for generating or for helping generate robotic navigational control signals.

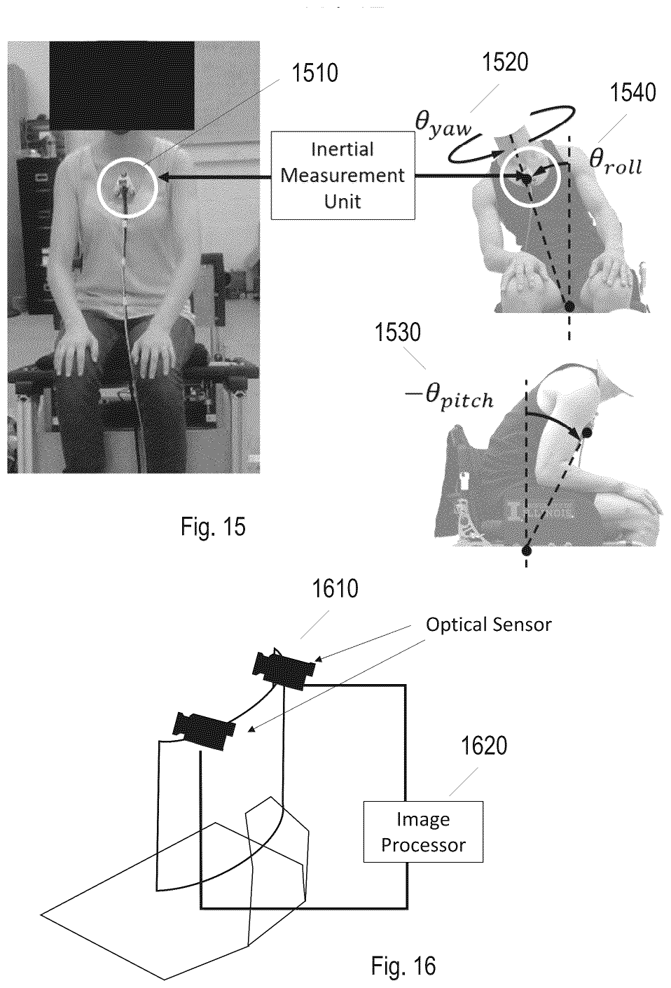

FIG. 15 illustrates utilization of an IMU as part of the TES to facilitate detection of torso kinematics for the robotic control described above. The IMU 1510 may be configured as a wearable device for the controlling entity. It may be configured to measure the torso posture characterized by, for example, yawing angle 1520 θ_{yaw}, pitching angle 1530 θ_{pitch}, and rolling angle 540 θᵣₒₗₗ, as indicated in FIG. 15.

For example, the IMU 1510 may be attached to the controlling entity's manubrium since it offered a flat and accessible surface for the IMU to be placed on for both male and female riders. In some example implementations, a commercially available industrial grade 9-axis IMU may be used since it is a small (35 mm×33 mm×9 mm) and light (0.15 kg) wearable device. The IMU may be configured to quantify the 3D torso angles in terms of 3D intrinsic Euler angles in “XYZ” order such that the yaw (θ_{yaw}), pitch (θ_{pitch}), and roll (θᵣₒₗₗ), representing the motions of torso twisting, leaning anterior/posterior, and leaning laterally/medially, respectively, as shown in FIG. 15. In some example implementations, desired estimation requirements of the IMU may include an angular detection range of, for example, −180° to 180° and accuracy of, for example, 6° or other angular accuracy considered as the maximum allowable root-means-squared error (RMSE) for accurately estimating human joint angles. The 3D angles from the IMU may be recorded by a microcontroller at 100 Hz. A transceiver (e.g., MAX3232, Texas Ins., USA) may be included and used to convert, e.g., RS-232 signals (−5V to +5V) from the IMU to, for example, TTL signals (−3.3V to 5V) for the microcontroller.

The IMU, for example, may include a plurality of gyroscope, a plurality of accelerometers, and/or a plurality of magnetometers. For example, the IMU may include a 3-axis gyroscope (or multiple gyroscopes with lower number of axis), a 3-axis magnetometer (or multiple magnetometers with lower number of axes), and a 3-axis accelerometer (or multiple accelerometers with lower number of axes). In some example implementations, an on-board algorithm based on Extended Kalman Filter or other types of algorithms may be utilized to compute the 3D Euler angles (e.g., VN-100, VectorNav, USA) from the IMU sensing output. The algorithm may utilize the integration of readings from the 3-axis gyroscopic to provide faster and smoother estimates of 3D Euler angles. Gyroscopes are subjected to bias instabilities, however, causing the integration of the gyroscopic readings to drift over time due to the inherent noise properties (e.g., gyro bias) of the gyroscope. Thus, the example algorithm above may use the accelerometer and magnetometer measurements to continuously estimate the gyro bias and compensate for this drift. The algorithm may further rely on the 3-axis accelerometer to estimate the direction of gravity, serving as reference for determining θ_{pitch} and θᵣₒₗₗ. Similarly, the 3-axis magnetometers may be used to estimate the direction of the Earth's magnetic field, serving as a reference for computing θ_{/yaw}.

In some example implementations, the IMU may be configured for use in a Relative Heading Mode (RHM), as a selectable mode among a plurality of modes, in which the dependence on the magnetometer readings may be reduced for computing the 3D angles to reduce effects of magnetic disturbances in an indoor environment. The RHM mode may allow more stable computation of relative θ_{yaw} (which equals 0 at the start-up of the IMU) resistant to nearby magnetic disturbances at the expense of computing absolute θ_{yaw} (which would be equal to 0 when the IMU was aligned to the Earth's magnetic North). This may be achieved, for example, by using only the minimal information from the magnetometer data to correct for the gyroscopic bias and drift behavior. The algorithm may be configured constantly to monitor the stability of the magnetic field and maintained stable θ_{yaw} if the surrounding magnetic field is stable. While RHM could not compute absolute θ_{yaw}, it may be suitable for the applications (e.g., the PURE application) above because computing the relative θ_{yaw} rather than the absolute θ_{yaw} may be sufficient for achieving the hand-free (HF) control, and magnetic disturbance rejection is critical for indoors where magnetometers are often unreliable.

FIG. 16 further illustrates utilization of an optical system as part of the TES to facilitate detection of torso kinematics for the robotic control described above. The optical system, for example may include optical sensors 1610 and a signal processing circuitry, e.g., image processor 1620 for processing detected optical information for generating robotic control signals. For example, multiple depth information may be extracted from the optical signal in order to estimate the kinematics of the torso of the controlling entity.

Any combinations of the sensing elements above may be used in an example TES. For example, for the PURE application, both the FSS and the IMU components may be integrated and adapted to jointly estimate the kinetics and kinematics of the torso of the seating controlling entity in order to generate control signal for robotic navigation.

For testing of any of the instrumented seat above, research grade force plates and/or camera motion capture system (e.g., Oqus 500, Qualisys, Sweden) may be integrated for simultaneous kinetics and kinematics measurements to compare to the above TES and other sensing elements. A predefined torso movement sequence may be designed for a test subject to perform and the detection of the research grade sensors and the practical TES and other sensors above are compared for evaluation of the performance of the practical TES and other sensing elements. The series of torso motions to evaluate may include but are not limited to neural, leaning forward/backward, leaning left/right, leaning diagonal left/right, twisting, leaning forward+twisting, leaning left+twisting, leaning right twisting, leaning diagonal left+twisting, and leaning diagonally right+twisting.

In some example implementations, the TES above (e.g., including the instrumented seat FSS and the IMU) may be used to control a physical robot (e.g., the PURE system) or a virtual robot, as shown in FIG. 1. In particular, the torso motions or positions/postures, as detected and parameterized by the TES may be mapped to actions and/or states of the robot. For example, a certain motion of the torso may be mapped to an action of the robot (e.g., turning, breaking, accelerating, stopping). For another example, certain positional or posture state of the torso may be mapped to a motion state of the robot (e.g., forward leaning positions of different angles, when maintained, may be mapped to a particular speed of the robot).

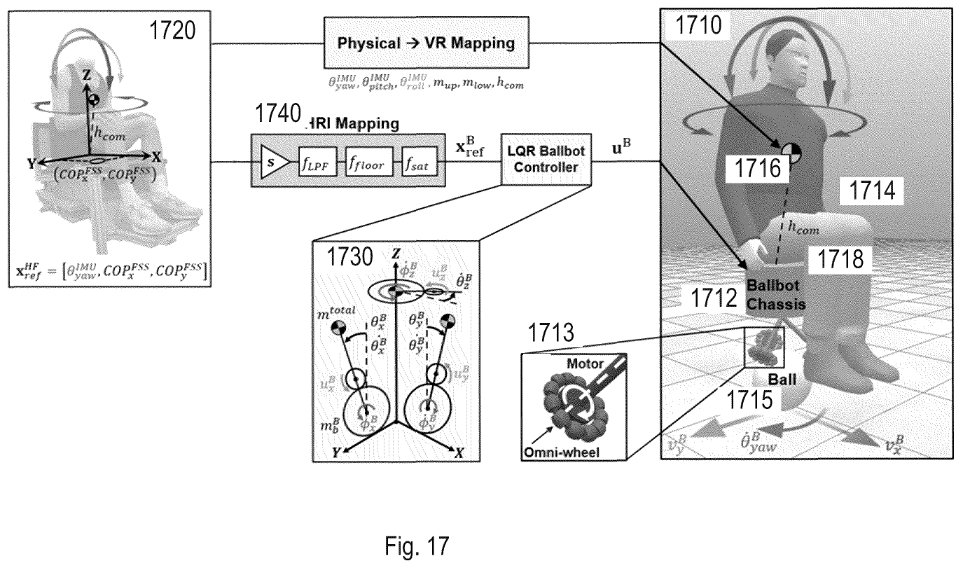

In some implementations for virtual robot control, as illustrated in FIG. 17, a virtual environment 1710 may be created in which a virtual robot 1712 (a virtual wheelchair, for example) may be created that replicates the physical controlling entity seating with the TES as shown in 1720. The controlling entity may be modeled as a virtual counterpart 1714 riding the virtual robot 1712 in the virtual environment 1710. The physical torso kinetics and kinematics as determined by the TES may be used for replicating the virtual counterpart of the controlling entity and the virtual robot in the virtual environment. Further, the virtual robot may be navigated in the virtual environment (include passages and obstacles) based on the physical torso kinetics and kinematics as detected by the TES. Such a system may provide, for example, a training platform for someone to learn how to ride a physical robot, and for customize/optimize the processing/mapping of TES detection and control signals for different robots with different driving train and motion characteristics.

The mapping between torso kinetics and/or kinematics to the virtual rider may, for example, involving modeling the rider with movable upper trunk 1716 and a seated lower body 1718 in the virtual environment 1710 and mapping the detected positions (leaning angles and twisting angles) and motions of the physical rider to the (θ_{yaw}, θ_{pitch}, θᵣₒₗₗ) of the upper trunk of the virtual rider.

The mapping of the physical torso motions and positions as detected by the TES to the virtual robot navigation may be implemented in various manners. For example, the driven train of the virtual robot, e.g., a virtual PURE system, may be modeled. The PURE system, for example, may be modeled by a cylinder representing the chassis of the PURE system with three evenly spaced omni-wheel and motor pairs 1713 balancing on a ball 1715. The virtual motors may be modeled as torque controlled, and the virtual omni-wheels may be modeled as a collection of rollers with passive joints around the outer perimeter of the omni-wheel.

The velocity control of the virtual robot may be achieved by mapping the interface signals from the TES. For HF control, the motion of the subject's COP measured by the FSS in x and y directions (COP^{FSS}, COP^{FSS}), and torso twist angle measured by the IMU θ_{yaw} may be mapped to control robot velocity in the forward/backward direction (vₓ^{B}), left/right direction (v_{y}^{B}), and rotational motion (\dot{θ}_{z}^{B}), respectively.

An example Linear Quadratic Regulator (LQR) controller may be used to dynamically stabilize the ballbot with the virtual rider and to control the velocity of the ballbot by tracking the states of the ballbot, as shown by 1730. The controller may track angular positions and velocities of the chassis in the sagittal and frontal planes (θₓ^{B}, \dot{θ}ₓ^{B}, θ_{y}^{B}, \dot{θ}_{y}^{B}), angular velocities of the ball in the sagittal and frontal planes (\dot{ψ}ₓ^{B}, \dot{ψ}_{y}^{B}), and the yaw angular velocity of the chassis in the transverse plane (\dot{θ}_{z}^{B}). Thus, seven states (x^{B}=[θₓ^{B}, \dot{θ}ₓ^{B}, θ_{y}^{B}, \dot{θ}_{y}^{B}, \dot{θ}_{z}^{B}, \dot{ψ}ₓ^{B}, \dot{ψ}_{y}^{B}]) may be used to stabilize and control the movements of the virtual ballbot. Three planar models of the ballbot may be used for controlling the movement in the sagittal, frontal, and transverse planes independently. The torques of the actuating wheels from the planar models may be mapped to the torques of the three motors in 3D using Jacobian transformations.

The signals from the TES 1720 interfaces may be preprocessed and mapped as reference velocities of the ballbot x^{B}, as shown by 1740 of FIG. 17. The first four elements of x^{B}, for example, may represent the states of the ballbot in the translational x and y directions. These elements may be set to zero because the ballbot needs to be balanced dynamically. The next three elements of x_{ref}^{B} may be sources of input reference signals, which were x_{ref}^{HF}=[θ_{z}^{IMU}, COP_{y}^{FSS}, COPₓ^{FSS}] for HF:

$${x}_{ref}^{k} = [ {θ}_{x}^{B} , {\dot{θ}}_{x}^{B} , {θ}_{y}^{B} , {\dot{θ}}_{y}^{B} , {\dot{θ}}_{z}^{B} , {\dot{ϕ}}_{x}^{ B} , {\dot{ϕ}}_{y}^{ B} = [ {0}_{1 \times 4} , {x}_{ref}^{HF} ]$$

Before being mapped as the ballbot's reference velocities x_{ref}^{B}, the HF interface signals x_{ref}^{HF} (or x_{ref}^{IF}) may be preprocessed to accommodate for user sensitivity preference and provide stable reference signals for the ballbot controller:

$${x}_{ref , k}^{B} = {f}_{sat} ( {f}_{floor} ( {f}_{LPF} ( {s}^{IF} \cdot {x}_{ref , k - 1}^{IF} , {x}_{ref , k - 1}^{B} , {α}^{LPF} ) , {x}_{min} ) , {x}_{max} )$$

where k represented the kth data index and k−1 represented the previous reference signals from HF.

First, the interface reference signal x_{ref}^{HF} may be adjusted to match the subject's preference by multiplying a sensitivity factor (e.g., s^{HF}=[sₓ^{HF}, s_{y}^{HF}, s_{z}^{HF}] T for HF control) to the reference signal. The value for s^{HF} may be adjusted for each subject during the VR training course. Higher sensitivities allowed navigation of the ballbot using smaller torso movements which could be helpful for mWCUs with less torso mobility.

Second, the reference signal from the interface may be preprocessed by a low pass filter, flooring function, and saturation function, as shown in 1740 of FIG. 17. For example, a first order digital IIR low pass filter (ƒ_{LPF}) may be added to smooth the adjusted interface reference signal and ballbot velocity reference signals. The ƒ_{LPF} may requires three arguments: 1) reference signals adjusted to the subject's sensitivity factor (s^{HRI}·x_{ref,k-1}^{HRI}), 2) previous ballbot states (x_{ref,k-1}^{B}), 3) smoothing factor (α^{LPF}). In some example implementations, heuristically-tuned smoothing factor of α^{LPF}=[0.85]_{3×1} may be used.

Further, a flooring function (ƒ_{floor}) that brings the reference signals to zero when being below a certain value (xₘᵢₙ=[0.05°/s, 0.05 m/s, 0.05 m/s]) may be used to minimize unwanted movement of the ballbot when input signals were close to zero, in order to completely brake to a full stop. For HF control, the controlling entity may not precisely move its torso back to their predefined neutral position (defined by averaging the COP data from the FSS for 5s while the it faces forward and sat comfortably upright), causing small non-zero COP readings. Thus, the flooring function also helps the controlling entities to brake completely by removing these small non-zero readings and unwanted drifting of the ballbot. The floor function may be implemented as:

$${f}_{floor} ( x , {x}_{min} ) = \{ \begin{matrix}{[ 0 ]}_{3 \times 1} & if & \vert x \vert < {x}_{min} \\ x & i f & \vert x \vert \geq {x}_{min}\end{matrix}$$

Further, in some example implementations, a saturation function (ƒₛₐₜ) may be added to prevent the ballbot from reaching excessively high speeds (xₘₐₓ=[10°/s, 2 m/s, 2 m/s]). The processed interface signals (x_{ref}^{B}) may be input as reference signals for the virtual ballbot controller to track. The saturation function may be implemented as:

$${f}_{sat} ( x , {x}_{max} ) = \{ \begin{matrix}{x}_{max} & if & \vert x \vert < {x}_{max} \\ x & if & \vert x \vert \leq {x}_{max}\end{matrix}$$

The above process may be utilized in a virtual training courses for training and testing purposes. The rider may be provided with virtual reality (VR) equipment to view the virtual scene and navigate the robot in the virtual scene. For example, in the VR scene, the rider may first go through a training course and then a test course to evaluate the performance when using the HF torso control interface above in comparison to some other interface, e.g., a joy stick (JS) interface. The virtual training and testing courses may be designed to replicate realistic and challenging indoor environments. Both courses may include different zones including but not limited to wide hallway, medium hallway, narrow hallway, zones with moving obstacles, table zones, a bathroom stall, and slalom course. The wide (e.g., 2.4 m), medium (e.g., 1.8 m), and narrow (e.g., 1.2 m) widths simulate a large public building (e.g., hospital) hallway width, average residential hallway width, and narrow residential hallway width, respectively. Each hallway zone, for example, may contain various sub-zones (e.g., straight, left turn, and right turn). The lengths of straights and the turns may vary, e.g., may be the same for all hallway widths. Zones with moving obstacles may contain three virtual human figures walking at a slow (e.g., 1.1 m/s), medium (e.g., 1.4 m/s), and fast (e.g., 1.7 m/s) pace. The table zones contained a number of (e.g., 3) tables with various sizes (e.g., 1.0 m×2.5 m) for the rider to navigate the robot (e.g., the ballbot) between the obstacles to test the lateral sliding omnidirectional capability of the rider and virtual ballbot. Within the table zones, there may be multiple (e.g., 2) subzones with varying gap sizes between the tables: narrow (e.g., 1.4 m), medium (e.g., 2.0 m), and wide (e.g., 2.6 m). A bathroom stall that followed the ADA standards may also be included to test the spinning capability of the virtual ballbot. Lastly, an example slalom course with four cones with a gap of, e.g., 2.0 m may be added since slalom is a commonly used practice course for wheelchair users. The testing course is configured with a different course layout, colors, and texture than the training course to prevent the rider from memorizing the course layout.

The goal of the training course is to 1) familiarize the rider with the control interfaces (i.e., HF and JS control) and the VR environment since navigation in VR can cause motion sickness, and 2) find the rider's preferred sensitivity settings. The rider may be randomly started with either HF or JS control to navigate through the training course using a TV monitor before using a VR headset. Some riders expressed nausea or dizziness when immediately put into the VR scene since the visual (e.g., moving in VR) and proprioceptive (e.g., sitting still in real world) perception may be different. This discomfort was more pronounced when the sensitivities are not tuned or when the subject is unfamiliar with the pendulum-like dynamics behavior of the ballbot. Thus, a TV monitor may be used prior to the use of the VR headset for subjects to minimize the rider's discomfort in VR and get accustomed to the basic principles of the interfaces. In addition, the rider may understand the overall layout of the training course and tune the sensitivity settings to their preference. The sensitivity tuning process may involve the rider verbally asking an on-site investigator to increase the sensitivity of the chosen interface incrementally (the initial sensitivity may be set to the lowest setting) governing translational and rotational velocities of the virtual ballbot. After using the TV monitor, the rider may wear the VR headset and may be allowed to explore each control interface by freely navigating in an open area (12.8 m×12.8 m) using their sensitivity settings. The rider may be asked to navigate through a simple square (7.3 m×7.3 m) course with a narrow (1.38 m) hallway width multiple times using steering and sliding maneuvers. Once the riders are comfortable with the interface and the VR scene, they may complete the remainder of the training course. During the entire training process, the rider may be allowed to change the sensitivity settings. If the rider expresses any discomfort while using the VR, a short break (˜1 minute) was given. If the rider collides during the training process, they would respawn at the beginning of the zone and repeat the zone until they could complete it without colliding. The subject may be told to complete each zone without colliding (prioritizing safety) at their comfortably fast speed.

The goal of the test course may further include evaluating the performance of the HR interfaces using the preferred sensitivity settings defined from the training course. The task for the rider may be to safely navigate through various zones of the test course without colliding into static/moving obstacles or walls. Unlike the training course, the rider may not adjust the sensitivity in the test course. If the subject expresses any discomfort while using the VR, a short break (˜1 minute) may be given. The riders may be randomly given either HF or JS control to begin navigating through the test course. The riders may be provided the following instructions: “The goal is to complete this course without any collisions; speed is not the top priority. Prioritize safety first.” After some time, e.g., 5 minutes of rest, the same procedure may be repeated for the other interface once the subject finished using the first interface.

In summary, the disclosure above relates generally to robotic control and is specifically directed to a Torso-dynamics Estimation System (TES) to estimate the leaning and twisting torso motions of a seated user and use the estimation or measurement signals to control the movement of physical or virtual devices or avatars. For example, these signals can be used in lean-to-steer scenarios where the seated user is a rider/driver in a personal mobility device (e.g., powered chair or scooter), vehicle (e.g., car or drone), or humanoid robot/avatar that could be in the physical or virtual worlds.

The basis of the TES is the ability to measure the the user's leaning motions (in the anterior-posterior and medial-lateral directions) and the torso twisting motion (angular position, velocity, and/or acceleration). These torso motion signals can then be used as control signals for movement of the physical or virtual devices or avatars.

In some embodiments, these estimated torso motions may be captured using an instrumented seat (Force Sensing Seat, FSS), a wearable sensor (inertial measurement unit, IMU), and or other vision, pressure, and/or force sensing devices to quantify the translational (e.g., leaning in all directions) and rotational (e.g., twisting) motions of the torso, respectively. However, other embodiments are possible.

TES can be applied in robotics, gaming, vehicle navigation, or possibly heavy equipment operation. The TES can be used as a human-robot interface to control physical mobility devices (e.g., self-balancing devices) using the user's torso movements. The benefit of controlling a mobility device with the user's torso includes freeing of hands to enable multi-tasking capabilities for the user (e.g., hold a cup of coffee or other items). The TES can be mounted on the mobility device to directly control the device. In addition, the TES can be mounted outside of the device to remotely control the device. In this use case, the TES can be used to teleoperate in physical and/or virtual environments, systems such as an avatar, robot, vehicle, or device. In addition to these examples, the TES might be useful for some control aspects of heavy machinery, such as backhoes, or manufacturing or healthcare areas, such as robotic limbs. The TES provides a hands-free control of the virtual robot/figure, enabling the user to utilize their hands for other tasks while using the torso for control of specific tasks. In addition, the TES can offer valuable information (e.g., user's weight, upper body posture, center of pressure) that could be used in the system's safety and performance.

The description and accompanying drawings above provide specific example embodiments and implementations. Drawings containing device structure and composition, for example, are not necessarily drawn to scale unless specifically indicated. Subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A system, comprising:
a Torso-dynamics Estimation System (TES) configured to determine real-time kinetics information and/or real-time kinematics information of a torso of a seated subject; and
a controller configured to:
process the real-time kinetics information and/or the real-time kinematics information to generate a set of detected torso motions or a set of detected torso positions; and
generate control signals for navigating a robotic device based on the set of detected torso motions or the set of detected torso positions.

2. The system of claim 1, wherein the TES comprises:
an instrumented seat; and
a wearable sensor.

3. The system of claim 2, wherein the instrumented seat is configured to determine the real-time kinetics information of the torso and the wearable sensor is configured to determine the real-time kinematics information of the torso.

4. The system of claim 3, wherein the instrumented seat comprises a base and a seating platform floatingly coupled to the seating platform.

5. The system of claim 4, wherein the seating platform is floatingly coupled to and supported by a plurality of axial loadcells.

6. The system of claim 5, wherein the plurality of axial loadcells comprise 6 uniaxial loadcells configured in three normal directions.

7. The system of claim 6, wherein a number axial loadcells arranged in a direction most aligned with gravity is larger than numbers of axial load cells in other directions.

8. The system of claim 5, wherein the plurality of axial loadcells are configured symmetrically around a vertical axis.

9. The system of claim 8, where the plurality of axial loadcells comprise 6 uniaxial load cells.

10. The system of claim 5, wherein each of the plurality of axial loadcells comprises two force members and are coupled to the seating platform and the base via ball joints.

11. The system of claim 10, wherein the ball joints for the plurality of axial loadcells on the base are not located in a single plane.

12. The system of claim 3, wherein the wearable sensor comprises an Inertial Measurement Unit (IMU) worn by the seated subject.

13. The system of claim 12, wherein the IMU comprises at least one 3-axis gyroscope, one 3-axis accelerometer, and one 3-axis magnetometer.

14. The system of claim 3, wherein the TES further comprises at least one of an instrumented backrest and an optical sensor.

15. The system of claim 14, wherein the TES comprises the instrumented backrest and the instrumented backrest comprises a plurality of angular/linear position sensors for detecting the real-time kinetics information of the torso.

16. The system of claim 14, wherein the TES comprises the instrumented backrest which comprises a movable backrest, a fixed lumbar support, a base, and prismatic and/or revolute joints, the movable backrest being configured to be moveable and always in contact with the seated subject.

17. The system of claim 16, wherein a number of the prismatic and/or revolute joints ranges from 1˜6, a combination of the prismatic and/or revolute joints being adaptably configured.

18. The system of claim 17, wherein the joints are configured in a parallel or serial configuration with respect to the movable backrest.

19. The system of claim 17, wherein each of the prismatic joints comprises a linear spring, a position sensor, and a sliding mechanism.

20. The system of claim 17, wherein each of the revolute joints comprises a torsional spring, an angle sensor, a bearing, and a rotating mechanism.

21. The system of claim 16, wherein the moveable backrest and the lumbar support are adjustable in terms of height and depth.

22. The system of claim 14, wherein the TES comprises the instrumented backrest and the instrumented backrest is adjustable to accommodate physiques of the seated subject.

23. The system of claim 15, wherein the plurality of angular/linear position sensors are arranged in a parallel or serial configuration.

24. The system of claim 14, wherein the TES comprises the instrumented backrest and the instrumented backrest comprises at least one pressure sensitive pad for detecting the real-time kinetics information of the torso.

25. The system of claim 3, wherein the system further comprises a wheelchair having a ballbot driving train, and wherein the base of the instrumented seat is integrated with a frame of the wheelchair.

26. The system of claim 3, wherein the system further comprises a wheelchair having a ballbot driving train, and wherein instrumented seat is detachably coupled to the wheelchair.

27. The system of claim 3, wherein the set of detected torso positions are mapped to the control signals for setting a robotic motion whereas the set of detected torso motions are mapped to the control signals for changes of the robotic motion.

28. The system of claim 5, wherein the plurality of axial loadcells comprise 4 uniaxial loadcells configured such that the loading axes are aligned in the same direction, which is orthogonal to the base and seating platform.

29. The system of claim 5, wherein a 6-axis force/torque sensor is placed between the base and seating platform.
